(19) United States
(12) Patent Application Publication
(10) Pub. No.: US 2017/0244642 A1
(43) Pub. Date: Aug. 24, 2017

(54) MULTI-DIMENSIONAL PACKET CLASSIFICATION

(71) Applicant: MICROSOFT TECHNOLOGY LICENSING, LLC, REDMOND, WA (US)

(72) Inventors: Hadi Katebi, Bellevue, WA (US); Daniel M. Firestone, Seattle, WA (US); George Varghese, Cupertino, CA (US)

(21) Appl. No.: 15/052,671

(22) Filed: Feb. 24, 2016

(51) Int. Cl. H04L 12/851; H04L 12/743; H04L 12/741

(52) U.S. Cl. CPC H04L 47/2441; H04L 45/74; H04L 45/7453

(57) ABSTRACT

Methods, media, and systems for implementing packet routing rules are provided for herein. In some embodiments, a packet routing rule is received that is to be applied to network packets in accordance with conditions identified by the packet routing rule. The conditions including a first condition associated with a first header field and a second condition associated with a second header field. In embodiments, a first cost associated with searching a first classifier for the packet routing rule utilizing the first condition and a second cost associated with searching a second classifier for the packet routing rule utilizing the second condition can then be determined. The packet routing rule can then be stored in a selected one of the first and second classifiers, based, at least in part, on the first and second cost. Other embodiments may be described and/or claimed herein.

### BACKGROUND

In a packet switched network, information transmitted over the network is generally divided into smaller blocks of data. These blocks of data are then transmitted over the network in the form of packets. Each of these packets includes control information in the form of a header of the packet and one or more of the blocks of data as a payload of the packet. The control information is used in routing the packet through the network to ensure that the packet arrives at an intended destination.

Packet classification generally refers to categorizing these packets into flows, where packets identified by the control information as belonging to the same flow are processed in a similar manner in accordance with a predefined set of rules. Under the current state of the art, packet classification is generally implemented as a linked-list of rules The linked-list of rules are generally sorted based on a priority associated with each rule and then searched in a linear fashion utilizing the control information of a packet to identify a rule that is applicable to the packet. This approach, however, does not scale well as the number of rules grows and can become particularly inefficient where, for example, tens of thousands of rules can be defined. As such, packets being processed utilizing this approach may cause a continually increasing delay for the network as the number of rules grows.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments described herein include methods, computer-storage media, and systems for implementing packet routing rules. In various embodiments, a collection of classifiers configured to store a set of packet routing rules can be implemented in a packet routing system of a network. At a high level, the packet routing system supports a multi-dimensional packet classification scheme in which a set of packet routing rules can be divided across multiple classifiers. By dividing the packet routing rules across multiple classifiers, a packet routing rule can be stored in a classifier that provides for a reduction in cost associated with looking up the individual packet routing rule as compared with other possible classifiers for the packet routing rule. As such, the multi-dimensional packet classification scheme described herein can provide for a scalable approach to packet classification which can reduce network latency caused by looking up rules for packet classification.

In operation, the collection of classifiers can include, for example, a first classifier associated with a first header field and a second classifier associated with a second header field, a header fields associated with the classifiers corresponds to header fields of packets to be received in the packet routing system. The packet routing rules are also defined based on the header fields. The packet routing system can receive and store a packet routing rule into the classifiers that is to be applied, in accordance with conditions identified within the packet routing rule, to network packets being routed through the network. These conditions can include, for example, a first condition associated with a first header field of the network packets and a second condition associated with a second header field of the network packets. In embodiments, a first cost associated with searching the first classifier for the packet routing rule utilizing the first condition can be determined. In addition, a second cost associated with searching the second classifier for the packet routing rule utilizing the second condition can then be determined. The packet routing rule can then be stored in a selected one of the first and second classifiers, based, at least in part, on the first and second cost.

In other embodiments, a packet may be received by the packet routing system. In such embodiments, a header of the packet can be analyzed by the packet routing system to identify a value of a header field contained within the header. Utilizing the value of the header field, a set of classifiers, associated with the header field, can be searched to identify a packet routing rule applicable to the packet. In such embodiments, the set of classifiers can include a first classifier associated with a first condition type of the header field and a second classifier associated with a second condition type for the header field. These condition types can include, for example, a specific value condition type, a range of values condition type, a prefix condition type, or the like. The identified packet routing rule can then be applied to the packet.

### BRIEF DESCRIPTION OF THE DRAWINGS

The present disclosure is described in detail below with reference to the attached drawing figures.

FIG. 1 is a block diagram of a network environment in which various embodiments of the present disclosure can be employed.

FIG. 2 depicts a block diagram illustrating a representation of header fields and associated sets of classifiers, in accordance with various embodiments of the present disclosure.

FIG. 3 depicts an illustrative rule partitioning of a rule set across a plurality of classifiers, in accordance with various embodiments of the present disclosure.

FIG. 4 depicts an illustrative rule set and a corresponding trie classifier, in accordance with various embodiments of the present disclosure.

FIG. 5 is a flow diagram depicting an illustrative process flow for inserting a rule into a collection of classifiers, in accordance with various embodiments of the present disclosure.

FIG. 6 is a flow diagram depicting an illustrative process flow for identifying and applying a rule to a packet, in accordance with various embodiments of the present disclosure.

FIG. 7 is a block diagram of an illustrative computing environment suitable for use in implementing embodiments described herein.

FIG. 8 depicts an illustrative distributed computing environment in which implementations of the present disclosure may be employed.

### DETAILED DESCRIPTION

Embodiments of this disclosure implement a multi-dimensional packet classification scheme in which a set of packet routing rules can be divided across multiple classifiers. By dividing the packet routing rules across multiple classifiers, a packet routing rule can be stored in a classifier that provides for a reduction in cost associated with looking up the individual packet routing rule as compared with other possible classifiers for the packet routing rule. As such, the multi-dimensional packet classification scheme described herein can provide for a scalable approach to packet classification which can reduce network latency caused by looking up rules for packet classification.

The subject matter of embodiments of this disclosure are described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion below, embodiments are described with reference to a system for implementing a multi-dimensional packet classification system; the system can implement several components for performing the functionality of embodiments described herein. Components can be configured for performing novel aspects of embodiments, where “configured for” comprises “programmed to” perform particular tasks or implement particular abstract data types using code. It is contemplated that the methods and systems described herein can be performed in different types of operating environments having alternate configurations of the functional components. As such, the embodiments described herein are merely illustrative, and it is contemplated that the techniques may be extended to other implementation contexts.

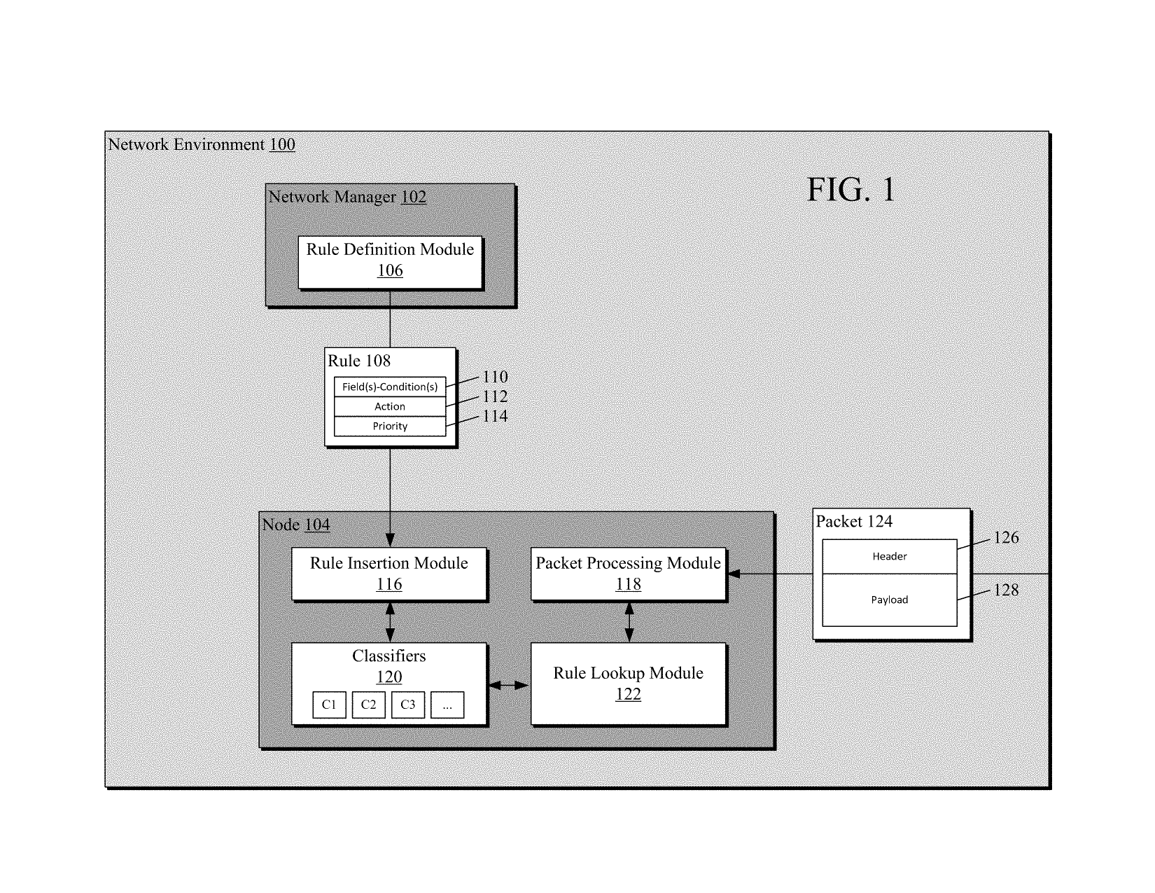

FIG. 1 is a block diagram of a network environment 100 in which various embodiments of the present disclosure can be employed. It will be appreciated that network environment 100 depicts only a portion of a network system for the sake of simplicity and ease of explanation. As such, it will be appreciated that any number of additional components (e.g., additional nodes, routers, switches, etc.), virtual or otherwise, can be included without departing from the scope of this disclosure.

As depicted network system 100 includes network manager 102 and node 104. Network manager 102 can be configured to enable a user (e.g., network administrator) to manage a network, or any portion thereof. Such a network can be a wired network, wireless network, or any combination thereof. In addition, such a network can be software defined, hardware defined, or any combination thereof. In embodiments, node 104 can be configured to, among other things, implement network traffic flow aspects of environment 100, such as, for example, classifying network packets into a packet flow, applying predefined rules to a packet flow, routing the network packets, etc.

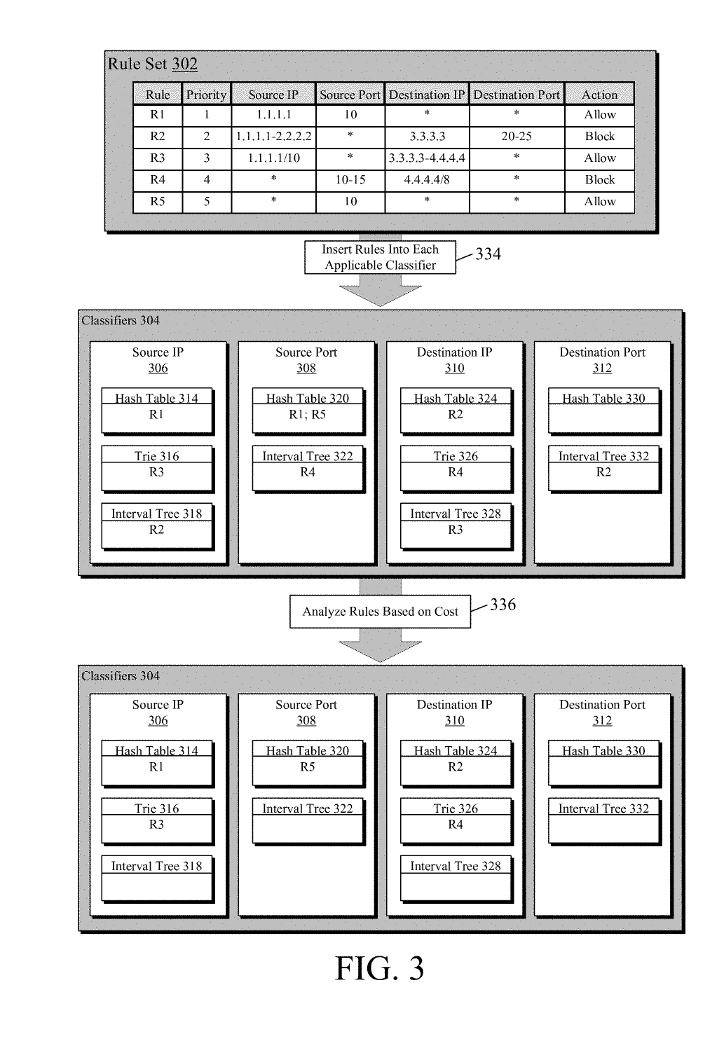

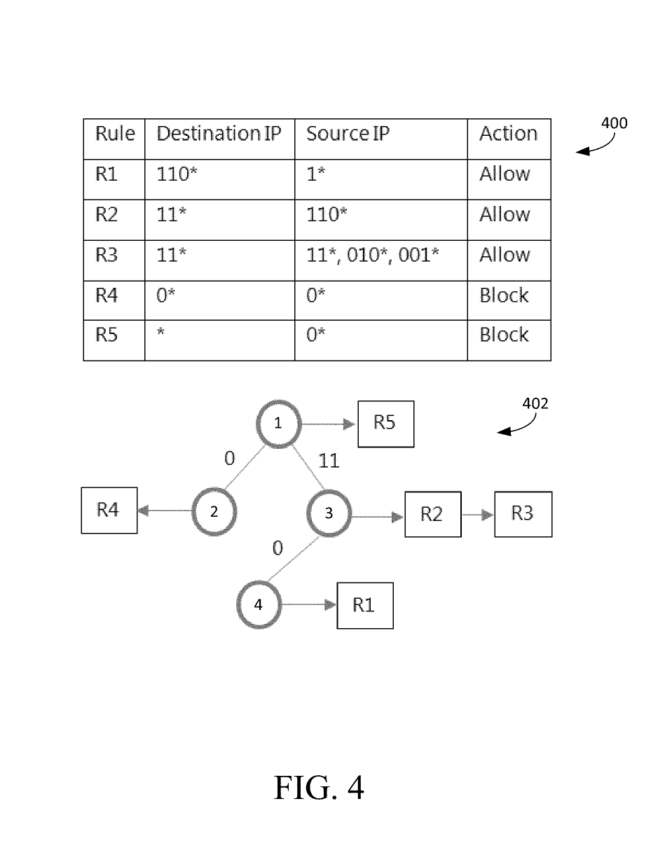

Network manager 102 includes rule definition module 106. Rule definition module 106 can be configured to enable a user of network system 100 to define one or more packet routing rules, hereinafter merely referred to as a rule or rules for simplicity, (e.g., rule 108) that can be utilized in classifying packets into packet flows. Each of these rules can identify a number of fields that could be present in the headers, or control information, of the packets, and a number of conditions respectively associated with those fields (e.g., field(s)-condition(s) 110). Such fields, within a header of a packet, may be referred to herein as header fields. The identification of such a field within a rule can also be referred to herein as a header field class. These header field classes can correspond with the header fields that are included within the header of a packet. Header fields can include, for example, a protocol field, a source internet protocol (IP) address field, a source port field, a destination IP address field, a destination port field, or the like, or any combination thereof. The conditions, on the other hand, can identify values for the respective header fields that the header fields of a packet would need to satisfy in order for the packet to be subject to the rule. Packets that are subject to the same rule are considered to be in the same packet flow. Illustrative rules are depicted in rule set 302 of FIG. 3 and rule set 400 of FIG. 4.

To enable the user to define these rules, rule definition module 106 can be configured to allow the user to select, or identify, the header fields that the user would like to utilize in applying the rule. Such selection could take any form, such as a drop down selection of fields, checkbox selection of fields, text box entry of fields, etc. It will be appreciated that these are merely illustrative mechanisms for selecting, or identifying fields, for a rule and that any suitable mechanism is explicitly contemplated by this disclosure.

The rule definition module 106 can also be configured to enable the user to define the conditions associated with the selected header fields under which the rule is to be applied. These conditions can be expressed within the rule as, for example, values associated with one or more of the header fields. In embodiments, these values can be expressed as various different types of conditions, or condition types. These different types of conditions can include, for example, one or more specific values (e.g., specific source IP address), one or more ranges of values (e.g., a range of destination ports), or one or more identified prefix values (e.g., identification of classless inter-domain routing (CIDR) block), a wildcard value, etc. A wildcard value generally refers to a value that can represent any value. Such a value is typically represented by an asterisk character (‘*’), question mark character (‘?’), etc. It will be appreciated that these types of conditions are merely meant to be illustrative of possible types of conditions and that other condition types can be used in conjunction with, or alternatively to, these illustrative condition types.

The rule definition module 106 can also be configured to enable the user to define one or more actions (e.g., action 112) that are to be applied to packets that are subject to the rule. These actions can include, for example, blocking the packet, allowing the packet, queueing the packet, scheduling the packet, or any other suitable action.

In embodiments, because a single packet can satisfy multiple rules, rule definition module 106 can also enable a user to designate a priority associated with the rule. Such a priority can be utilized to indicate which rule is to be applied to a packet where the packet satisfies the conditions of multiple rules. In some embodiments, such priorities can be expressly assigned to the rules through the user explicitly designating a priority within the rule. In other embodiments, such priorities can be inferred, for example, based on an order of the rules. For example, a rule that occurs earlier in a list could have a higher priority than a rule that occurs later in the list.

While the examples described above are in reference to user defined rules, such rules could also be programmatically defined. For example, security software on a network may determine that packets received from a range of IP addresses are intended to disrupt the network (e.g., a denial of service attack). In such an example, the security software may generate a rule that indicates packets received from that range of IP addresses are to be blocked. It will be appreciated that any mechanism for defining rules is expressly contemplated herein, and the manner in which the rules are defined should not be limiting of this disclosure.

Once a rule has been defined, rule definition module 106 can be configured to transmit the rule (e.g., rule 108) to node 104. Node 104 includes rule insertion module 116, packet processing module 118, classifiers 120, and rule lookup module 122. Each of these components can be communicatively coupled with one another (e.g., via a bus) as depicted, or in any other suitable manner to enable communication between these components. It will be appreciated that, while depicted herein as discreet components, such a depiction is merely selected for ease of explanation and that the functionality of these components can be combined into fewer components or further divided into more components without departing from the scope of this disclosure. In addition, each of these components can be implemented via software, hardware, or any combination thereof without departing from the scope of this disclosure.

Each of the classifiers in classifiers 120 represent data structures that are configured to store a collection of rules to be applied to packets routed through, or by, node 104. While the term “classifier” may generally refer to a table of rules in the art, as used herein, the term “classifier” may refer to a data structure that is utilized to store and match rules in an efficient manner (e.g., based on a condition type of a rule). In embodiments, each classifier can be associated with a respective header field that corresponds to a header field that can be included in packets to be processed by the system. The association of such a header field with a classifier can also be referred to herein as a header field object, and these header field objects can correspond with the header fields that are included within the header of a packet. In some embodiments, this classifier to header field relationship can be a one-to-one relationship where, for each header field, one classifier is associated therewith. In other embodiments, this classifier to header field relationship can be a one-to-many relationship where, for each header field, a set of classifiers is associated therewith. As an example, classifiers 120 could include one or more classifiers associated with a source IP address field, another one or more classifiers associated with a source port field, another one or more classifiers associated with a destination IP address field, and yet another one or more classifiers associated with a destination port field.

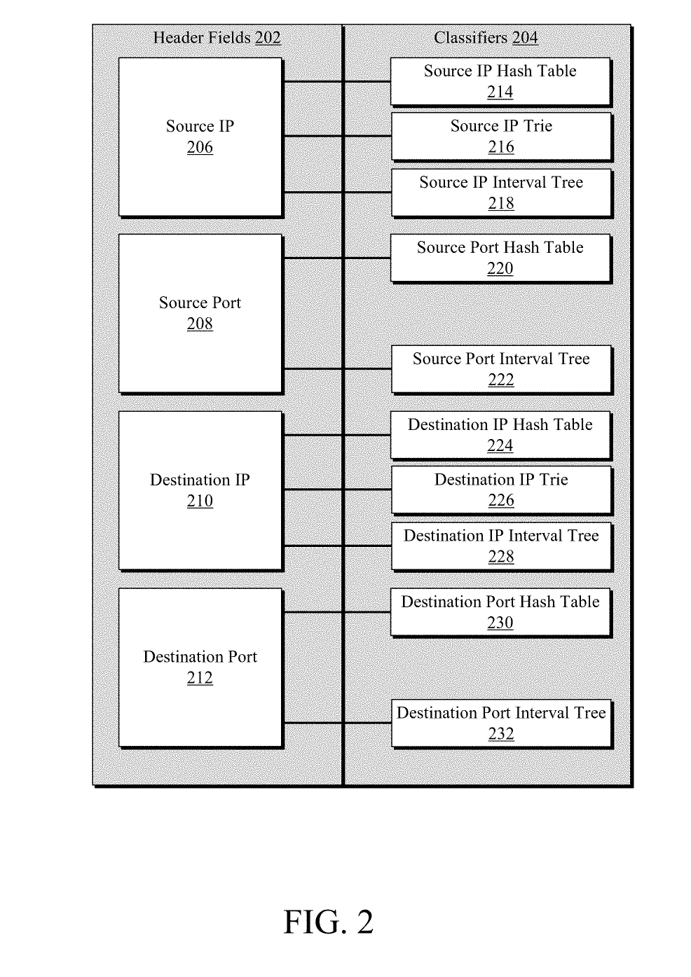

In embodiments where a set of classifiers are associated with each header field, each classifier in the set of classifiers can be further associated with a condition type, of a plurality of condition types for the respectively associated header field. As mentioned previously, condition types can include, for example, a specific value condition type, a range condition type, a prefix condition type, or any other suitable condition type. In these embodiments, the data structure of each classifier can be selected based on what is better suited for the associated condition type. For example, a specific value condition type may be better suited to being stored in a hash table, whereas a range condition type may be better suited to being stored in an interval table, and a prefix condition type may be better suited to being stored in a trie (e.g., trie classifier 402 of FIG. 4). Such a configuration is depicted by classifiers 204 of FIG. 2, and classifiers 304 of FIG. 3.

Rule insertion module 116 can be configured to receive rule 108 from network manager 102 and store rule 108 in a selected classifier that reduces at least a cost of looking up rule 108 in the selected classifier, as compared with looking up rule 108 in the remaining classifiers. To accomplish this, rule insertion module 116 can extract, or identify, the header fields that are identified within rule 108, along with the associated conditions. Rule insertion module 116 can then utilize the header field classes to determine classifiers (e.g., C1-C3) from classifiers 120 in which the rule could be inserted. In embodiments where a set of classifiers is associated with each header field, rule insertion module may further analyze the associated conditions extracted from rule 108 to determine a condition type of each of the associated conditions. In such embodiments, the determination of the classifier in which rule 108 could be inserted can also be based on the determined condition type.

Once the classifiers in which rule 108 could be inserted have been determined, rule insertion module 116 can be configured, in embodiments, to insert rule 108 into each of the determined classifiers. For example, if rule 108 includes a source IP address field and a destination IP address field, then rule insertion module 116 could insert rule 108 into a first classifier (e.g., C1) associated with the source IP address field and a second classifier (e.g., C2) associated with the destination IP address field. It will be appreciated that, in some embodiments, such insertions could be restricted to those header fields included within rule 108 that are not associated with wildcard conditions. The insertion of a rule into a classifier can be accomplished by creating a node, if one does not exist, within the data structure of the classifier for a selected condition and attaching the rule to the node. Where such a node already exists, the rule can be inserted into a rule list of the node. A rule list can be, for example, a linked list.

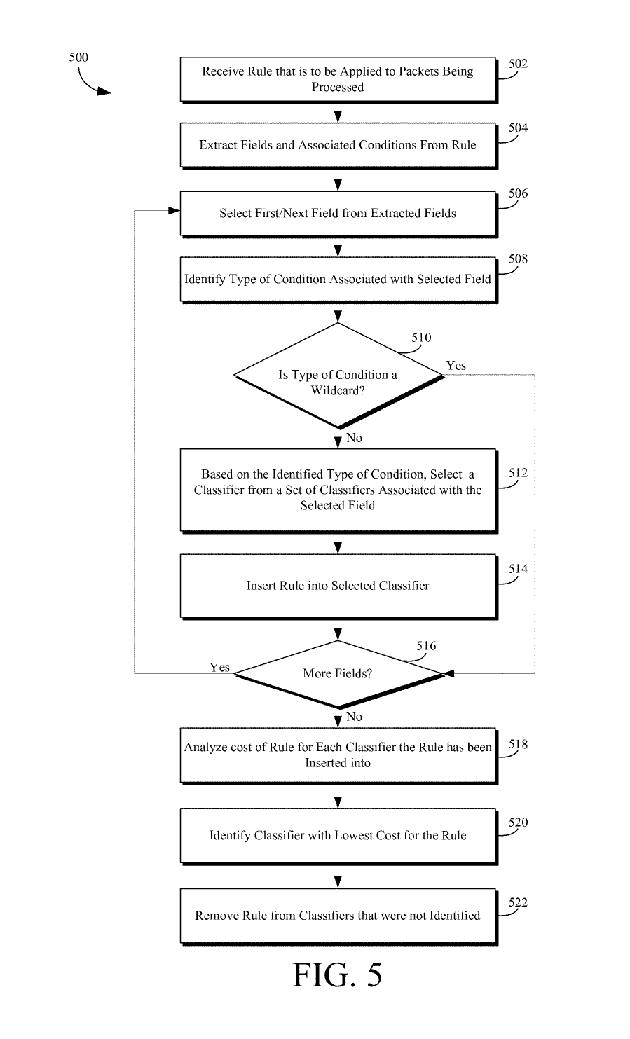

Once rule 108 has been inserted into the determined classifiers, rule insertion module 116 could then determine a cost associated with looking up rule 108 in each of the determined classifiers. Such a cost can be referred to herein as a lookup cost and is discussed in greater detail below in reference to block 518 of FIG. 5. The classifier that is determined to have a lower lookup cost could then be selected as the classifier in which rule 108 is to be stored and rule 108 could be removed, or deleted, from the classifier(s) that was not selected. In such an embodiment, the result is that rule 108 would be stored in one classifier that has been determined to have a reduced, or minimized, lookup cost for rule 108, without redundancy of rule 108 in other classifiers of classifiers 120. As such, a union of the classifiers in classifiers 120 would include each rule only a single time.

In addition to the above discussed lookup cost determination, in some embodiments, the selected classifier could also be based on a measure of the impact, if any, that the insertion of rule 108 has on the rules that have been previously inserted into the determined classifiers. For example, if a classifier is a linked list, then the insertion of rule 108 would impact the lookup cost for each of the rules that occur within the linked list after rule 108. Such a cost can be referred to herein as an impact cost. In such embodiments, the lookup cost and the impact cost can both be taken into account when determining which classifier has a lower overall cost. Such an embodiment is discussed in reference to FIG. 4, below.

It will be appreciated that a rule might have multiple conditions associated with a header field. For example, a rule might have 10 destination CIDR IP blocks and 20 source IP ranges. If this rule is inserted, for example, into a trie classifier of destination IP, the rule would be inserted 10 times, once for each destination CIDR IP block. In such a scenario, the cost associated with the rule (e.g., lookup cost and/or impact cost) would be calculated for each of the 10 insertions and the cost would be aggregated into a total cost for the multiple conditions of the rule.

In some embodiments, it will be appreciated that, in addition to the above described classifiers, classifiers 120 may also include a default classifier. Such a default classifier can be utilized for instances where a rule, for which no classifiers can be determined, could be inserted. In embodiments, such a classifier can take the form of a linked list or other suitable data structure.

In some embodiments, rather than merely inserting rule 108 into a selected classifier, rule insertion module 116 may be configured to, upon receipt of a new rule to be inserted into classifiers 120, repartition the rules across classifiers 120. To accomplish this, the existing rules within classifiers 120 may be initially deleted from classifiers 120 (e.g., by initializing all classifiers, except for, in some embodiments, the default classifier discussed above). Once the existing rules have been deleted from classifier 120 each of these existing rules along with the new rule can be inserted into classifiers 120 as described above. In some of these embodiments, rather than removing, or deleting, the rules from the non-selected classifiers, the rules can be deleted from all classifiers (e.g., by de-initializing the re-initialized all of the classifiers, including the default classifier). These rules can then be reinserted into the selected classifier that is determined to have a lower lookup cost for each rule. Where a classifier has not been selected for a rule, that rule can be inserted into the default classifier.

In some embodiments, rule insertion module 116 can also be configured to delete an existing rule from classifiers 120. In such embodiments, the rule to be deleted can be passed to rule insertion module 116, which in turn can delete the rule from classifiers 120 based on the conditions defined within the rule.

Node 104 can also include a packet processing module 118. Packet processing module 118 can be configured to receive a packet (e.g., packet 124) that is being routed to, or through, node 104. In embodiments, packet processing module 118 can extract, or identify, header fields and associated values from a header (e.g., header 126) of the packet. Packet processing module 118 can utilize these header fields and associated values to classify the packet, based on the rules contained within classifiers 120. In embodiments, to accomplish this classification, packet processing module 118 can be configured to pass the extracted header fields and associated values to rule lookup module 122.

Rule lookup module 122 can be configured to identify, based on the associated values of the extracted header fields, a set of rules whose conditions are satisfied by the associated values of the extracted header fields. As used herein, a condition associated with a selected header field can be satisfied, for example, if the value of that header field from the packet matches a value defined by the condition, falls within a range defined by the condition, or matches a prefix defined by the condition. To identify the set of rules, rule lookup module 122 can be configured to search a classifier, or set of classifiers, associated with each of the extracted header fields for rules whose conditions are satisfied by the associated values of the extracted header fields. From the identified set of rules, the rule having the highest priority can be selected and returned to packet processing module 118. Packet processing module 118 can then apply the action defined by the selected rule to packet 124. In some embodiments, it will be appreciated that, rather than passing the entire rule to packet processing module 118, rule lookup module 122 can merely pass the action that is to be applied to packet 124 to packet processing module 118.

In some embodiments, it will be appreciated that the above lookup process performed by the rule lookup module 122 to identify a selected rule that applies to a packet flow can be carried out for a first packet within a packet flow and cached (e.g., by rule lookup module 122) for remaining packets in the packet flow. The selected rule can be cached, for example, in a hash table or other suitable data structure. As an example, with respect to the transmission control protocol/internet protocol (TCP/IP), the above lookup process can be performed by the rule lookup module 122 for the initial SYN packet of the TCP/IP handshake to identify a selected rule that applies to the SYN packet. The selected rule can then be cached for remaining packets of the TCP/IP session.

While network manager 102 and node 104 are depicted as being comprised of specific components, it will be appreciated, that additional or fewer components can be included without departing from the scope of this disclosure. In addition, while network manager 102 and node 104 are depicted as being separate entities, it will be appreciated that, in some embodiments, network manager 102 and node 104 can be integrated together to form a single entity. While discussed throughout this disclosure in reference to classifying rules, it will be appreciated that the framework described in this disclosure is extensible to other areas as well. For example, the framework described herein can be extended to storing generic routing encapsulation (GRE) keys as opposed to rules. A person of skill in the art will readily recognize this extensibility.

FIG. 2 depicts a block diagram illustrating a representation of header fields 202 and associated sets of classifiers in classifiers 204, in accordance with various embodiments of the present disclosure. Header fields 202 include illustrative examples of possible header fields. As can be seen, these example header fields include Source IP 206, Source Port 208, Destination IP 210, and Destination Port 212. Each of header fields 202 is associated with a set of classifiers depicted in classifiers 204. The association between header fields 202 and each of the classifiers represented in classifiers 204 is depicted by the lines connecting each header field with the associated classifiers.

Classifiers 204 depict various data structures 214-232 that are configured to store rules that include a condition directed towards the respectively associated header field. For example, the classifiers, Source IP Hash Table 214, Source IP Trie 216, and Source IP Interval Tree 218, each store rules that define a condition directed towards header field Source IP 206. The classifiers, Source Port Hash Table 220 and Source Port Interval Tree 222, each store rules that define a condition directed towards header field Source Port 208. The classifiers, Destination IP Hash Table 224, Destination IP Trie 226, and Destination IP Interval Tree 228, each store rules that define a condition directed towards header field Destination IP 210. Likewise, the classifiers, Destination Port Hash Table 230 and Destination Port Interval Tree 232, each store rules that define a condition directed towards header field Destination Port 218.

In addition to the association with a respective header field, in some embodiments each of the classifiers can be further associated with a specific type of condition for which the data structure is adapted. For example, Source IP Hash Table 214, Source Port Hash Table 220, Destination IP Hash Table 224, and Destination Port Hash Table 230 can be configured to store rules whose condition type is a specific value (e.g., specific Source IP Value). Source IP Trie 216 and Destination IP Trie 226 can be configured to store rules whose condition type is a prefix condition type, (e.g., a CIDR block). Source IP Interval Tree 220, Source Port Interval Tree 222, Destination IP Interval Tree 228, and Destination Port Interval Tree 232 can be configured to store rules whose condition type is a range of values (e.g., a range of Destination Port Values). In such embodiments, an appropriate classifier in which to store a rule can be based on, not only a specific header field, but also a type of condition directed towards that specific header field. Examples of this are discussed in greater detail in reference to FIG. 3, below.

It will be appreciated that the header fields depicted in header fields 202 are merely meant to be illustrative of possible header fields. In addition, it will also be appreciated that the various condition types and associated data structures discussed above are merely meant to be illustrative, and additional condition types and/or associated data structures can vary depending on implementation.

FIG. 3 depicts an illustrative rule partitioning of a rule set 302 across a plurality of classifiers 304, in accordance with various embodiments of the present disclosure. As depicted, rule set 302 includes rules R1-R5. Each of rules R1-R5 includes a priority, a selection of header fields with associated conditions, and an action to be taken with respect to packets that are subject to the respective rule. In particular, the header fields depicted include a source IP header field, a source port header field, a destination IP header field, and a destination port header field.

The collection of classifiers represented by classifiers 304 in turn include sets of classifiers 306-312 associated with each of the header fields included in rule set 302. As such, these sets of classifiers include a source IP set of classifiers 306, a source port set of classifiers 308, a destination IP set of classifiers 310, and a destination port set of classifiers 312. Each of the sets of classifiers includes a classifier directed towards different condition types that can be included with respect to the associated header field. For example, the source IP set of classifiers 306 includes: hash table 314 for a specific value condition type (e.g., specific Source IP address); Trie 316 for a prefix condition type, (e.g., a source IP address CIDR block); and interval tree 318 for a range condition type (e.g., a range of source IP addresses). It will be appreciated that classifiers 304 are composed of similar classifiers to those depicted in classifiers 204 of FIG. 2 presented in a different format.

Process blocks 334 and 336 depict procedures for performing the partitioning of rules R1-R5 across classifiers 304, which can be carried out, for example, by rule insertion module 116 of FIG. 1. Beginning with process block 334, rules R1-R5 are inserted into each applicable classifier for the respective rule. To elaborate on this insertion, each rule will be discussed in turn.

Beginning with rule R1, rule R1 includes a specific value condition type in the form of a specific IP address, ‘1.1.1.1,’ for the source IP header field. As such, rule R1 is inserted into hash table 314 of the source IP set of classifiers 306. In addition, rule R1 includes a specific value condition type in the form of a specific port number, ‘10,’ for the source port header field. As such, rule R1 is also inserted into hash table 320 of the source port set of classifiers 308. As can be seen, the condition types of the remaining header fields of rule R1 are wildcard condition types, which are not inserted into the respectively associated classifier sets.

Moving to rule R2, rule R2 includes a range condition type in the form of a range of IP addresses, ‘1.1.1.1-2.2.2.2,’ for the source IP header field. As such, rule R2 is inserted into interval tree 318 of the source IP set of classifiers 306. Rule R2 also includes a specific value condition type in the form of a specific IP address, ‘3.3.3.3,’ for the destination IP header field. As such, rule R2 is also inserted into hash table 324 of the destination IP set of classifiers 310. In addition, rule R2 includes a range condition type in the form of a range of port numbers, ‘20-25,’ for the destination port header field. As such, rule R2 is also inserted into interval tree 332 of the destination port set of classifiers 312. As can be seen, the condition type of the remaining header field, source port, of rule R2 is a wildcard condition type, which is not inserted into the respectively associated classifier set, source port classifier set 308.

Rule R3 includes a prefix condition type in the form of an IP address CIDR block, ‘1.1.1.1/10,’ for the source IP header field. As such, rule R3 is inserted into trie 316 of the source IP set of classifiers 306. Rule R3 also includes a range condition type in the form of a range of IP addresses, ‘3.3.3.3-4.4.4.4,’ for the destination IP header field. As such, rule R3 is also inserted into interval tree 328 of the destination IP set of classifiers 310. As can be seen, the condition types of the remaining header fields of rule R3 are wildcard condition types, which are not inserted into the respectively associated classifier sets.

Rule R4 includes a range condition type in the form of a range of source ports, ‘10-15,’ for the source port header field. As such, rule R4 is inserted into interval tree 322 of the source port set of classifiers 308. Rule R4 also includes a prefix condition type in the form of an IP address CIDR block, ‘4.4.4.4/8,’ for the destination IP header field. As such, rule R4 is also inserted into trie 326 of the destination IP set of classifiers 310. As can be seen, the condition types of the remaining header fields of rule R4 are wildcard condition types, which are not inserted into the respectively associated classifier sets.

Rule R5 includes a specific value condition type in the form of a specific source port, ‘10,’ for the source port header field. As such, rule R5 is inserted into interval tree 322 of the source port set of classifiers 308. As can be seen, the condition types of the remaining header fields of rule R5 are wildcard condition types, which are not inserted into the respectively associated classifier sets.

Once all of the rules have been inserted into each applicable classifier of the respective rule, at block 336 the inserted rules are analyzed based on a cost of including the rule in each of the applicable classifiers. As mentioned elsewhere herein, this cost analysis could include not only look-up cost of the rule, but also impact cost of the rule in each applicable classifier. As an example, rule R1 has been inserted into both hash table 314 of source IP classifier set 306 and hash table 320 of source port classifier set 308. Assuming all of the rules included within these classifiers are depicted, rule R1 would have the same look-up cost between either hash table 314 or hash table 320 as these are the same type of data structure. The impact cost of including rule R1 in each of these classifiers, however, differs. This is because rule R1 and rule R5 are both inserted into hash table 320. In addition, both rule R1 and rule R5 are directed towards source port ‘10.’ As such, it will be appreciated by a person of ordinary skill in the art, that the insertion of rule R1 would increase the look-up time associated with rule R5. The impact cost of including rule R1 in hash table 314, on the other hand, would essentially have no impact cost, because no other rules have been inserted into hash table 314. As a result, including rule R1 in hash table 314 would have the lowest overall cost associated therewith, and rule R1 would be removed from hash table 320 at block 336.

As another example, because the classifiers of rules R2-R4 each only include a single rule, the impact costs of including rules R2-R4 are basically the same between the various classifiers. As such, the look-up cost is the main consideration with each of the insertions of rules R2-R4. As a result, these insertions can be analyzed based on the data structure into which they are inserted. It will be appreciated that each of these data structures would have essentially equivalent look-up times where only a single rule is included in each; however, assume for the purposes of this example that a hash table is preferred over a trie based on look-up times, and a trie is preferred over an interval tree based on look-up times. Based upon this assumption, rule R2 has been removed from interval tree 318 and interval tree 332 and has been maintained in hash table 324; rule R3 has been removed from interval tree 328 and has been maintained in trie 316; and rule R4 has been removed from interval tree 322 and has been maintained in trie 326. Rule R5 was only included in a single classifier, therefore no analysis is necessary with respect to rule R5. Based on the above described partitioning, each of rules R1-R5 has been stored in the classifier having the lowest overall cost (i.e., lookup cost and impact cost).

FIG. 4 depicts an illustrative rule set 400 and a corresponding trie classifier 402, in accordance with various embodiments of the present disclosure. A trie is a tree whose keys are determined by traversing the tree, where each branch of the tree identifies a portion of the key. A trie can also be referred to in the art as a digital tree, radix tree, or prefix tree. Trie classifier 402 depicts rules, R1-R5, of rule set 400 inserted in accordance with the Destination IP header field. As such, trie classifier 402 could correspond with Destination IP Trie 226 of FIG. 2 or trie 326 of FIG. 3. In rule set 400, the priority of a rule is determined by its order within the rule set, where an earlier occurring rule has a higher priority than a later occurring rule. For example, rule R2 would have a higher priority than rule R3.

As depicted, trie 402 includes 4 nodes, each node leading to one or more rules associated with that node. The branches leading to each node define the condition under which the rules of each node could apply to an incoming packet. Whether an incoming packet is subject to any of rules R1-R5 can be determined by utilizing the destination IP value of the incoming packet and traversing the tree based on the characters that occur within the destination IP value from left to right. If a node of trie 402 is reached and no further branches can be taken from that node, then the rules at that node can be evaluated against the source IP value of the incoming packet to determine if any rules associated with that node apply. For example, traversing from node 1 to node 3 of trie 402 yields the key ‘11’. This key corresponds with both rules R2 and R3, which, as depicted here, are stored as a rule list off of node 3. In such an example, a packet that includes a destination IP header field value of ‘111.222.333.444’ could be subject to one of rules 2 or 3, depending upon the source IP value in the packet. If the source IP value of the packet is ‘010.111.111.111,’ then the packet would be subject to rule R3, and the packet would be allowed. If the source IP value is ‘110.111.111.111,’ then the packet would be subject to rule R2, and the packet would also be allowed. In the latter scenario where the source IP value is ‘110.111.111.111,’ it can also be seen that R3 could be applied, however, as discussed above, the order of the rules presented indicate that R2 would have a higher priority than R3. As a result, if both rules are applicable, then the higher priority rule, R2, would be applied. If, on the other hand, the source IP value is ‘210.111.111.111’ then neither of rules R2 or R3 would be applicable. In such a scenario, any rules associated with the parent of node 3 (i.e., node 1) would be evaluated to determine the applicability of any rules associated with the parent with respect to the packet. This is because the parent of the current node would have been traversed to reach the current node and therefore, any rules occurring at the parent node would also be applicable to the packet. As such, rule R5 would be evaluated to determine rule R5′s applicability to the packet. The source IP value of 210.111.111.111 does not match the source IP value of rule R5. Therefore no rules would be applicable to such a packet.

FIG. 5 is a flow diagram depicting an illustrative process flow 500 for inserting a rule into a collection of classifiers, in accordance with various embodiments of the present disclosure. Process flow 500 can be carried out, for example, by rule insertion module 116. As depicted process flow 500 begins at block 502 where a rule is received that is to be applied to packets being processed within a network. As described above, a rule can include one or more header fields along with respectively associated conditions. In addition, a rule can also include an action that is to be performed with respect to packets that are subject to the rule and/or a priority associated with the rule.

At block 504, the fields of the rule and the respectively associated conditions are extracted. This can be accomplished in any number of ways. For example, in some embodiments, the rule may define the conditions based upon a byte range layout of the fields within the rule. In such embodiments, the conditions can be extracted from the respective byte ranges and the associated header fields can be extracted by identifying the header field associated with the respective byte ranges. As another example, in other embodiments, the rule could define the header fields and associated conditions as field-condition pairs. In such embodiments these field-condition pairs could be extracted from the rule and then analyzed to determine the field and associated condition. It will be appreciated that the above examples are merely meant to be illustrative and that any format in which a rule can define conditions and associate each of those conditions with a respective field can be utilized without departing from the scope of this disclosure.

At block 506 a first field from the extracted fields can be selected, and at block 508, a type of condition associated with the selected field can be identified. The type of condition associated with the selected field can be based on an analysis of the extracted condition associated with the selected field. The type of conditions can include, for example, one or more specific values (e.g., specific source IP address), one or more ranges of values (e.g., a range of destination ports), or one or more identified prefix values (e.g., identification of classless inter-domain routing (CIDR) block), a wildcard value, etc.

At block 510 a determination is made as to whether the type of condition is a wildcard type of condition. If the type of condition is a wildcard type of condition then process flow 500 can proceed to block 516, discussed below. If, on the other hand, the type of condition is not a wildcard type of condition then process flow 500 can proceed to block 512.

At block 512 a classifier can be selected from a set of classifiers that are associated with the selected field based on the type of condition identified at block 508. For example, if the condition type is determined to be a specific value condition type, then a classifier that includes a hash table data structure can be selected. At block 514 the rule can be inserted into the selected classifier. The insertion of a rule into a classifier can be accomplished by creating a node, if one does not exist, within the data structure of the classifier for a selected condition and attaching the rule to the node. Where such a node already exists, the rule can be inserted into a rule list of the node. A rule list can be, for example, a linked list.

At block 516 a determination is made as to whether there are additional fields from the extracted fields that have yet to be processed. If there are additional fields in the rule, then process flow 516 can return to block 506 where a next field can be selected from the extracted fields and the above described process can be repeated. If there are no additional fields remaining, then process flow 500 can proceed to block 518.

The cost of the rule for each classifier that the rule has been inserted into is analyzed at block 518. This cost can include a lookup cost, an impact cost, or any other cost associated with the rule. In an example embodiment, the lookup cost can be divided into three sub-costs: 1) the cost of finding the node of the classifier that includes the rule within a rule list, 2) the cost of traversing the rule list of the node to get to the rule, and 3) the cost of matching against the remaining conditions within the rule's conditions. It should be noted that only sub-cost 1) is dependent on the respective classifier in which the rule was inserted, as such, in some embodiments, only the first sub-cost may be analyzed in determining which classifier. Furthermore, some sub-costs may be deemed to be more important to the determination of the lookup cost of the rule. In such a scenario, the sub-costs could be assigned different weights to account for the varying degrees of importance. As mentioned previously, the impact cost can be based on a measure of the impact, if any, that the insertion of the rule into a selected classifier has on the rules that have been previously inserted into the selected classifier. For example, if a classifier is a linked list, then the insertion of a rule would impact the lookup cost of each of the rules that occur within the linked list after the inserted rule. In embodiments, the lookup cost and the impact cost can be referred to collectively as an overall cost. In some embodiments, the overall cost can be defined as a linear combination of the lookup cost and the impact cost (i.e., overall cost=lookup cost+impact cost). In such embodiments, either the lookup cost or the impact cost could be of more concern and a weight could be assigned to one or both of the lookup cost or the impact cost.

At block 520, the classifier with the lowest cost for the rule is identified. In embodiments, this cost could refer to any of the costs discussed above, or any combination thereof. Finally, at block 522, the rule can be removed from those classifiers that were not identified. It will be appreciated that process flow 500 is merely meant to be illustrative of an example process flow. Additional procedures can be added and/or existing procedures can be removed or reordered within the process flow without departing from the scope of this invention.

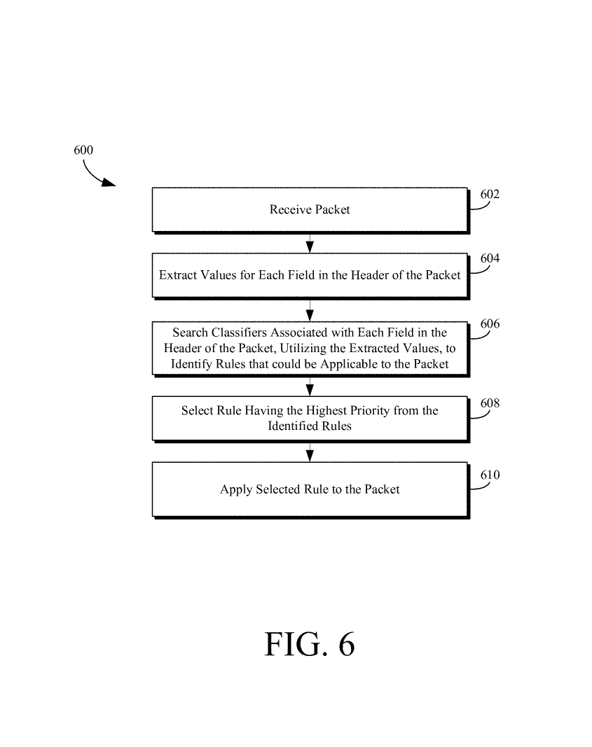

FIG. 6 is a flow diagram depicting an illustrative process flow 600 for identifying and applying a rule to a packet, in accordance with various embodiments of the present disclosure. Process flow 600 can be carried out, for example, by rule lookup module 122. As depicted process flow 600 begins at block 602 where a packet is received.

At block 604 values are extracted from each field in the header of the packet. As will be appreciated, the header of a packet is generally based upon a byte range layout of the fields within the header. In such a scenario, the conditions can be extracted from the respective byte ranges and the associated header fields can be extracted by identifying the header field associated with the respective byte ranges. It will be appreciated, however, that this is merely meant to be illustrative and that any format in which a header can define values for fields within the header can be utilized without departing from the scope of this disclosure.

At block 606, a classifier or set of classifiers associated with each field in the header of the packet are searched utilizing the extracted values to identify rules that could be applicable to the packet. At block 608, the rule having the highest priority can be selected from the rules identified at block 606. Finally, at block 610, the selected rule is applied to the packet.

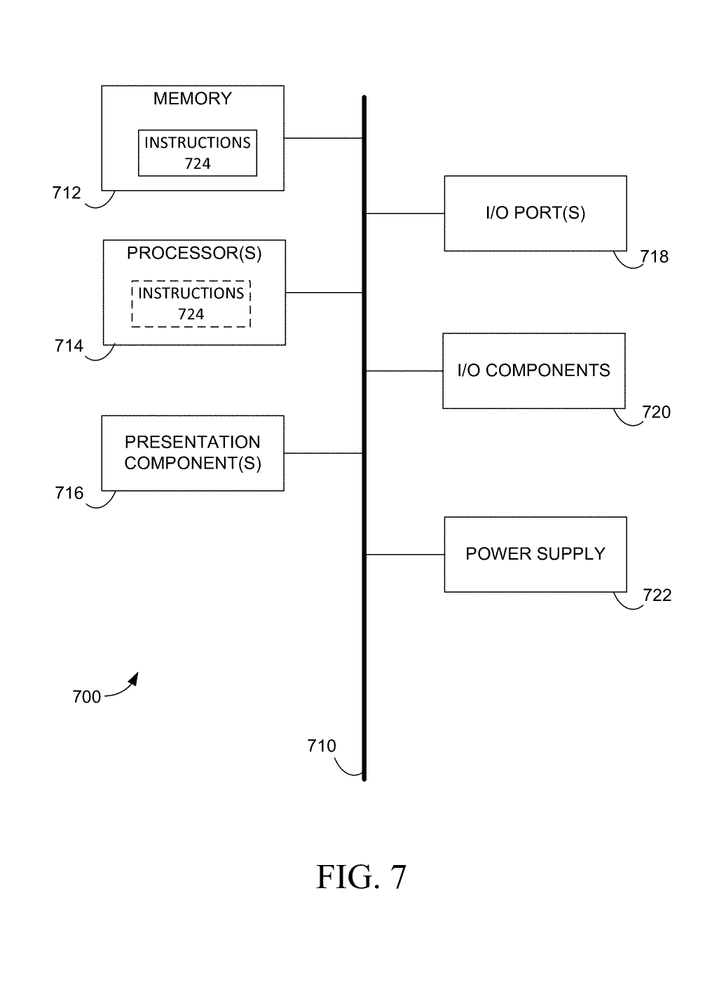

Having briefly described an overview of embodiments of the present disclosure, an illustrative operating environment in which embodiments of the present disclosure may be implemented is described below in order to provide a general context for various aspects of the present disclosure. Referring initially to FIG. 7 in particular, an illustrative operating environment for implementing embodiments of the present disclosure is shown and designated generally as computing device 700. Computing device 700 is but one example of a suitable computing environment and is not intended to suggest any limitation as to the scope of use or functionality of the disclosure. Neither should the computing device 700 be interpreted as having any dependency or requirement relating to any one or combination of components illustrated.

The disclosure may be described in the general context of computer code or machine-useable instructions, including computer-executable instructions such as program modules or engines, being executed by a computer or other machine, such as a personal data assistant or other handheld device. Generally, program modules including routines, programs, objects, components, data structures, etc. refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

With reference to FIG. 7, computing device 700 includes a bus 710 that directly or indirectly couples the following devices: memory 712, one or more processors 714, one or more presentation components 716, input/output ports 718, input/output components 720, and an illustrative power supply 722. Bus 710 represents what may be one or more busses (such as an address bus, data bus, or combination thereof). Although the various blocks of FIG. 7 are shown with clearly delineated lines for the sake of clarity, in reality, such delineations are not so clear and these lines may overlap. For example, one may consider a presentation component such as a display device to be an I/O component, as well. Also, processors generally have memory in the form of cache. We recognize that such is the nature of the art, and reiterate that the diagram of FIG. 7 is merely illustrative of an example computing device that can be used in connection with one or more embodiments of the present disclosure. Distinction is not made between such categories as “workstation,” “server,” “laptop,” “hand-held device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information. Computer-readable storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 712 includes computer storage media in the form of volatile and/or nonvolatile memory. As depicted, memory 712 includes instructions 724. Instructions 724, when executed by processor(s) 714 are configured to cause the computing device to perform any of the operations described herein, in reference to the above discussed figures. The memory may be removable, non-removable, or a combination thereof. Illustrative hardware devices include solid-state memory, hard drives, optical-disc drives, etc. Computing device 700 includes one or more processors that read data from various entities such as memory 712 or I/O components 720. Presentation component(s) 716 present data indications to a user or other device. Illustrative presentation components include a display device, speaker, printing component, vibrating component, etc.

I/O ports 718 allow computing device 700 to be logically coupled to other devices including I/O components 720, some of which may be built in. Illustrative components include a microphone, joystick, game pad, satellite dish, scanner, printer, wireless device, etc.

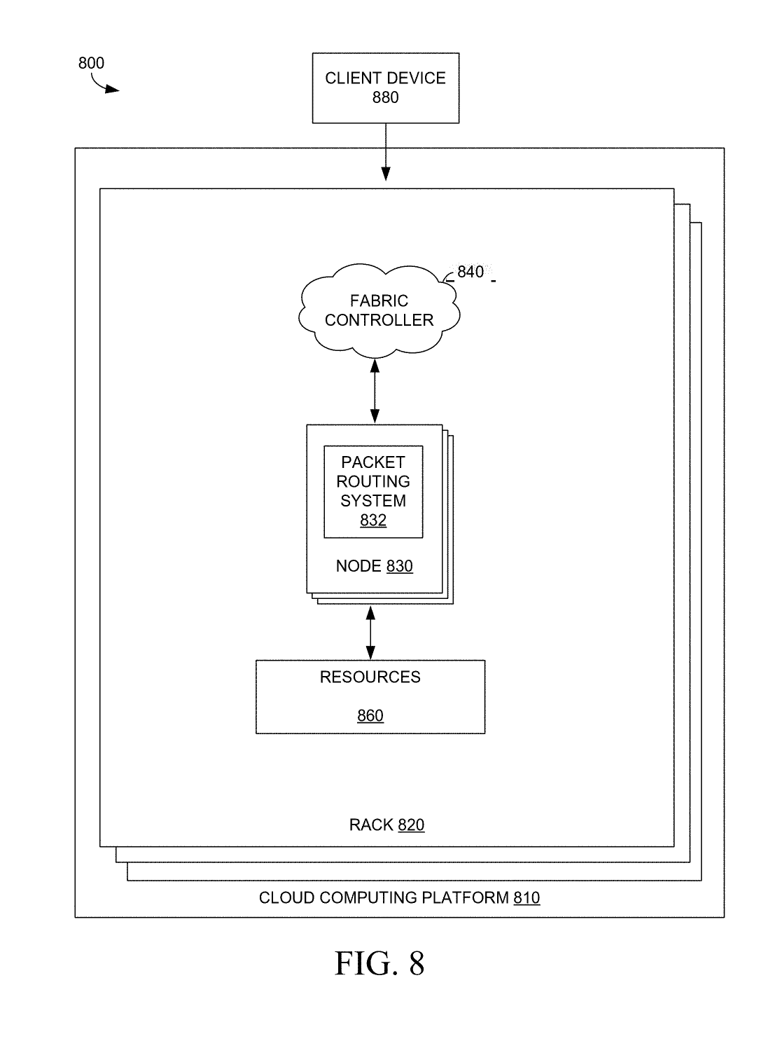

Referring now to FIG. 8, FIG. 8 illustrates an illustrative distributed computing environment 800 in which implementations of the present disclosure may be employed. In particular, FIG. 8 shows an illustrative network system comprising a cloud computing platform 810, where the system supports the packet routing functionality described above. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Data centers can support the distributed computing environment 800 that includes the cloud computing platform 810, rack 820, and node 830 (e.g., computing devices, processing units, or blades) in rack 820. The system can be implemented with a cloud computing platform 810 that runs cloud services across different data centers and geographic regions. The cloud computing platform 810 can implement a fabric controller 840 component for provisioning and managing resource allocation, deployment, upgrade, and management of cloud services. Typically, the cloud computing platform 810 acts to store data or run service applications in a distributed manner. The cloud computing infrastructure 810 in a data center can be configured to host and support operation of endpoints of a particular service application. The cloud computing infrastructure 810 may be a public cloud, a private cloud, or a dedicated cloud.

The node 830 can be provisioned with a packet routing system 832 (such as that described with respect to node 104 of FIG. 1. In addition, node 830 can also be configured to perform specialized functionality (e.g., compute nodes or storage nodes) within the cloud computing platform 810. The node 830 can be allocated to run one or more portions of a service application of a tenant. A tenant can refer to a customer utilizing resources of the cloud computing platform 810. Service application components of the cloud computing platform 810 that support a particular tenant can be referred to as a tenant infrastructure or tenancy. The terms service application, application, or service are used interchangeably herein and broadly refer to any software, or portions of software, that run on top of, or access storage and compute device locations within, a datacenter.

When more than one separate service application is being supported by the nodes 830, the nodes may be partitioned into virtual machines. Physical machines can also concurrently run separate service applications. The virtual machines or physical machines can be configured as individualized computing environments that are supported by resources 860 (e.g., hardware resources and software resources) in the cloud computing platform 810. It is contemplated that resources can be configured for specific service applications. Further, each service application may be divided into functional portions such that each functional portion is able to run on a separate virtual machine. In the cloud computing platform 810, multiple servers may be used to run service applications and perform data storage operations in a cluster. In particular, the servers may perform data operations independently but exposed as a single device referred to as a cluster. Each server in the cluster can be implemented as a node.

Client device 880 may be linked to a service application in the cloud computing platform 810. The client device 880 may be any type of computing device, which may correspond to computing device 800 described with reference to FIG. 8, for example. The client device 880 can be configured to issue commands to cloud computing platform 810. In embodiments, client device 880 may communicate with service applications through a virtual Internet Protocol (IP) and load balancer or other means that directs communication requests to designated endpoints in the cloud computing platform 810. The components of cloud computing platform 810 may communicate with each other over a network (not shown), which may include, without limitation, one or more local area networks (LANs) and/or wide area networks (WANs).

Having described various aspects of the distributed computing environment 800 and cloud computing platform 810, it is noted that any number of components may be employed to achieve the desired functionality within the scope of the present disclosure. Although the various components of FIG. 8 are shown with lines for the sake of clarity, in reality, delineating various components is not so clear, and metaphorically, the lines may more accurately be grey or fuzzy. Further, although some components of FIG. 8 are depicted as single components, the depictions are exemplary in nature and in number and are not to be construed as limiting for all implementations of the present disclosure.

Embodiments presented herein have been described in relation to particular embodiments which are intended in all respects to be illustrative rather than restrictive. Alternative embodiments will become apparent to those of ordinary skill in the art to which the present disclosure pertains without departing from its scope.

From the foregoing, it will be seen that this disclosure in one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A packet routing system to implement packet routing rules comprising:
one or more processors; and
a memory including a plurality of executable instructions which, when executed by the one or more processors, cause the packet routing system to:
implement a collection of classifiers that are to store a plurality of packet routing rules, the collection of classifiers including a first classifier associated with a first header field and a second classifier associated with a second header field;
receive a packet routing rule that is to be applied to network packets in accordance with conditions identified by the packet routing rule, the conditions including a first condition associated with the first header field and a second condition associated with the second header field;
determine a first cost associated with searching the first classifier for the packet routing rule utilizing the first condition and a second cost associated with searching the second classifier for the packet routing rule utilizing the second condition; and
store the packet routing rule in a selected classifier, of the first and second classifiers, based, at least in part, on the first and second cost.

2. The packet routing system of claim 1, wherein the plurality of instructions further cause the packet routing system to:
receive a packet having a header that includes values for each of a plurality of header fields, the values including a first value associated with the first header field and a second value associated with the second header field;
search a first set of classifiers, of the collection of classifiers, associated with the first header field utilizing the first value and a second set of classifiers, of the collection of classifiers, associated with the second header field utilizing the second value to identify a set of packet routing rules that are applicable to the packet;
apply a selected packet routing rule, of the set of packet routing rules, to the packet based on a priority of the selected packet routing rule.

3. The packet routing system of claim 1,
wherein the plurality of classifiers include a set of classifiers associated with the first header field, the set of classifiers including the first classifier, the set of classifiers including a third classifier, wherein the first classifier is associated with a first condition type for the first header field and the third classifier is associated with a second condition type for the first header field.

4. The packet routing system of claim 3, wherein the first classifier includes a first data structure directed towards the first condition type and the third classifier includes a second data structure directed towards the second condition type, the first data structure and the second data structure being different from one another.

5. The packet routing system of claim 3, wherein:
the first classifier is associated with a specific value condition type; and
the third classifier is associated with a range of values condition type.

6. The packet routing system of claim 5, wherein:
the first data structure is a hash table data structure for storing a first set of packet routing rules, each packet routing rule of the first set of packet routing rules designating one or more specific values associated with the first header field; and
the second data structure is an interval tree data structure for storing a second set of packet routing rules, each packet routing rule of the second set of packet routing rules designating a range of values associated with the first header field.

7. The packet routing system of claim 6, wherein the set of classifiers include a fourth classifier associated with a third condition type for the first header field, the third condition type being a prefix value condition type, the fourth classifier including a trie data structure for storing a third set of packet routing rules, each packet routing rule of the third set of packet routing rules designating one or more prefix values associated with the first header field.

8. The packet routing system of claim 1,
wherein a union of the collection of classifiers includes each of the plurality of packet routing rules only once.

9. One or more computer-readable storage media having instructions stored thereon which, when executed by one or more processors, cause the one or more processors to:
receive a packet;
analyze a header of the packet to identify a value of a header field contained within the header;
utilizing the value of the header field, search a set of classifiers, associated with the header field, to identify a packet routing rule applicable to the packet, the set of classifiers including a first classifier associated with a first condition type for the header field and the second classifier associated with a second condition type for the header field; and
apply the packet routing rule to the packet.

10. The one or more computer-readable storage media of claim 9, wherein:
the first classifier includes a first data structure directed towards the first condition type, and
the second classifier includes a second data structure directed towards the second condition type, the first data structure and the second data structure being different from one another.

11. The one or more computer-readable storage media of claim 10, wherein:
the first classifier is associated with a specific value condition type and the first data structure is a hash table data structure for storing a first set of packet routing rules, each packet routing rule of the first set of packet routing rules designating one or more specific values associated with the header field; and
the second classifier is associated with a range of values condition type and the second data structure is an interval tree data structure for storing a second set of packet routing rules, each packet routing rule of the second set of packet routing rules designating a range of values associated with the header field.

12. The one or more computer-readable storage media of claim 11, wherein a union of the set of classifiers includes each of a plurality of packet routing rules only once.

13. The one or more computer-readable storage media of claim 11, wherein the set of classifiers include a third classifier associated with a third condition type for the header field, the third condition type being a prefix value condition type, the third classifier including a trie data structure for storing a third set of packet routing rules, each packet routing rule of the third set of packet routing rules designating one or more prefix values associated with the first header field.

14. The one or more computer-readable storage media of claim 10, wherein the instructions which cause the one or more processors to search the set of classifiers to identify the packet routing rule applicable to the packet further cause the one or more processors to:
search the first data structure to determine a first set of packet routing rules that are satisfied by the value of the header field and one or more additional values of one or more additional header fields of the packet;
search the second data structure to determine a second set of packet routing rules that are satisfied by the value of the header field and the one or more additional values;
identify the packet routing rule applicable to the packet from the first and second sets of packet routing rules based on a priority associated with each of the packet routing rules included within the first and second set of packet routing rules.

15. A computer implemented method to implement packet routing rules comprising:
receiving a packet routing rule that is to be applied to network packets in accordance with conditions identified by the packet routing rule, the conditions including a first condition associated with a first header field and a second condition associated with a second header field;
determining a first condition type based on the first condition and a second condition type based on the second condition;
identifying a first classifier from a first set of classifiers based on the first condition type, and a second classifier from a second set of classifiers based on the second condition type, the first set of classifiers being associated with the first header field and the second set of classifiers being associated with the second header field;
determining a first cost associated with searching the first classifier for the packet routing rule utilizing the first condition and a second cost associated with searching the second classifier for the packet routing rule utilizing the second condition; and
storing the packet routing rule in a selected classifier, of the first and second classifiers, based, at least in part, on the first and second cost.

16. The computer implemented method of claim 15, further comprising:
receiving a packet having a header that includes values of each of a plurality of header fields, the values including a first value associated with the first header field and a second value associated with the second header field;
searching the first set of classifiers, of the collection of classifiers, associated with the first header field utilizing the first value and the second set of classifiers, of the collection of classifiers, associated with the second header field utilizing the second value to identify a set of packet routing rules that are applicable to the packet;
applying a selected packet routing rule, of the set of packet routing rules, to the packet based on a priority of the selected packet routing rule.

17. The computer implemented method of claim 15, wherein the first classifier includes a first data structure directed towards the first condition type, and wherein the first set of classifiers includes a third classifier that includes a second data structure directed towards another condition type that is different from the first condition type, the first data structure and the second data structure being different from one another.

18. The computer implemented method of claim 17, wherein:
the first classifier is associated with a specific value condition type and the first data structure is a hash table data structure for storing a first set of packet routing rules, each packet routing rule of the first set of packet routing rules designating one or more specific values associated with the first header field; and
the third classifier is associated with a range of values condition type and the second data structure is an interval tree data structure for storing a second set of packet routing rules, each packet routing rule of the second set of packet routing rules designating a range of values associated with the first header field.

19. The computer implemented method of claim 15,
wherein the first cost is a first overall cost and the second cost is a second overall cost, and
wherein determining the first overall cost associated with searching the first classifier for the packet routing rule utilizing the first condition comprises:
determining a first lookup cost for locating the packet routing rule within the first classifier; and
determining a first impact cost for an impact that the packet routing rule has on one or more additional packet routing rules stored within the first classifier; and
calculating the first overall cost based on the first lookup cost and the first impact cost; and
wherein determining the second overall cost associated with searching the second classifier for the packet routing rule utilizing the second condition comprises:
determining a second lookup cost for locating the packet routing rule within the second classifier; and
determining a second impact cost for an impact that the packet routing rule has on one or more additional packet routing rules stored within the second classifier; and
calculating the second overall cost based on the secon lookup cost and the second impact cost.

20. The computer implemented method of claim 19,
wherein the first and second lookup costs and the first and second impact costs are weighted to reflect a relative importance of the first and second lookup costs as compared with the first and second impact costs.
